(19) United States
(12) Patent Application Publication
(10) Pub. No.: US 2007/0249417 A1
(43) Pub. Date: Oct. 25, 2007

(54) SYSTEMS AND METHODS FOR FACILITATING PLAY OF LOTTERY GAMES

(76) Inventors: JOHN M. PACKES, Hawthorne, NY (US); MICHAEL F. STEIB, New York, NY (US); ANDREW P. GOLDEN, Yarmouthport, MA (US); JAMES A. JORASCH, New York, NY (US); JAY S. WALKER, Ridgefield, CT (US); THOMAS M. SPARICO, New York, NY (US); STEPHEN C. TULLEY, Fairfield, CT (US); MICHAEL D. DOWNS, Stamford, CT (US)

Correspondence Address: WALKER DIGITAL MANAGEMENT, LLC, 2 HIGH RIDGE PARK, STAMFORD, CT, 06905, US

(21) Appl. No.: 11/424,732

(22) Filed: Jun. 16, 2006

Related U.S. Application Data
(63) Continuation of application No. 11/122,855, filed on May 5, 2005.
Application No. 11/122,855 is a continuation-in-part of application No. 09/930,717, filed on Aug. 15, 2001, now Pat. No. 6,964,611.
Application No. 11/122,855 is a continuation-in-part of application No. 09/437,204, filed on Nov. 9, 1999, now Pat. No. 6,244,957.
Application No. 09/437,204 is a continuation of application No. 08/774,487, filed on Dec. 30, 1996, now Pat. No. 6,012,983.
(60) Provisional application No. 60/225,319, filed on Aug. 15, 2000.

(51) Int. Cl. A63F 13/00

(52) U.S. Cl. 463/17

(57) ABSTRACT

Some embodiments of the present invention are directed to providing lottery outcomes and other types of lottery information to a player (e.g., in accordance with one or more preferences of a player). In some embodiments, lottery information may be provided over a network, via postal mail, via CD-ROM, and/or via a set-top device.

This application is a continuation-in-part of U.S. patent application Ser. No. 09/930,717, “SYSTEM AND METHOD FOR AUTOMATED PLAY OF LOTTERY GAMES” filed Aug. 15, 2001, which:
(i) claims the benefit of U.S. Patent Application No. 60/1225,319, “SYSTEMS AND METHODS FOR AUTOMATED LOTTERY GAME PLAY” filed Aug. 15, 2000; and
(ii) is also a continuation-in-part of U.S. patent application Ser. No. 09/437,204, “AUTOMATED PLAY GAMING DEVICE” filed Nov. 9, 1999; which is a continuation of U.S. Pat. No. 6,012,983, “AUTOMATED PLAY GAMING DEVICE” filed Dec. 30, 1996, and granted Jan. 11, 2000.
   The entirety of each of the above applications is incorporated herein by reference.

### BACKGROUND

The present invention relates generally to methods, systems, and apparatus for facilitating play of lottery games.

A purchase of a lottery ticket typically requires a visit to an authorized lottery agent, where the process varies depending on the type of game to be played. Some known types of games include “instant” tickets, or “scratch” tickets, where the winning status is apparent on the face of the ticket, and “Lotto” games, where the player picks or otherwise receives a set of entry numbers, and the status of the numbers is determined by comparison with numbers selected in a subsequent lottery drawing.

With respect to “scratch-off”-style or instant lottery games, a player typically purchases a paper or cardboard game ticket from a participating lottery agent. In the case of most instant lottery games, the player then reveals combinations of symbols or values by physically uncovering a portion of the game ticket that is concealed by a covering material, such as latex. Certain revealed combinations of symbols or values may correspond to prizes, which in some cases may be provided to a player at a participating lottery agent. Thus, once a player purchases a ticket, an outcome corresponding to the ticket may immediately be determined, and any resultant prize may then be claimed. The ability of a player of an instant lottery game to determine the value of a prize immediately upon purchase, or at his convenience, contributes to the appeal of instant lottery games.

The typical requirements of travel to a lottery agent and/or physical play of the ticket, however, may be a hardship on a player. Further, a potential player may decide not to purchase a lottery ticket because of these requirements, or may decide to purchase a lesser number of lottery tickets than desired. In addition, the overall cost associated with the production and distribution of physical game tickets may make it prohibitive or undesirable to offer instant tickets for sale below a certain price point, such as one dollar ($1.00).

Limited options have been made available whereby lottery tickets may be purchased without visits to a lottery agent. Some lotteries now offer subscription, or advance-play sales of “Lotto”-type lottery tickets. With a subscription ticket, lottery entries are automatically re-entered into drawings for a predefined number of weeks or drawings. Such subscription tickets may be made available at a discounted price. The Vermont State Lottery, for example, has offered multiple drawing “contracts,” or a subscription, whereby a player can enter selected numbers in multiple drawings.

Commonly-owned U.S. Pat. No. 5,871,398, “OFF-LINE REMOTE SYSTEM FOR LOTTERIES AND GAMES OF SKILL”, issued to Schneier, et al. (hereinafter the '398 patent), describes systems and methods for the electronic representation of instant lottery games via an electronic hand-held ticket viewer (HTV). As described in the '398 patent, the HTV may comprise a personal digital assistant (PDA) or other electronic device (e.g., a personal computer) having hardware and/or software means operable to facilitate the methods described therein.

A game of Keno typically consists of matching a series of player-selected numbers against a series of numbers drawn by the Keno system. Once the player has selected the series of numbers, the player selects a certain number of games for which those numbers are valid. Thus, by selecting several games, the player may bet on future games without further interaction with the system, much like subscription play lotteries. An establishment, such as a casino, typically determines how and when the outcomes of Keno games are provided to players. For example, the numbers are drawn by the system and broadcast or transmitted to a number of screens throughout the establishment. Furthermore, the Keno games and/or the drawing of numbers in Keno may continue indefinitely or in a continuous manner, without regard to: (i) a particular player's status; (ii) a particular player's participation; or (iii) the outcome of a prior game.

### BRIEF DESCRIPTION OF THE FIGURES

FIG. 1A is a view of an embodiment of a player device;

FIG. 1B is a view of an embodiment of a graphical display of the player device of FIG. 1A;

FIG. 2 is a view of a system according to one embodiment of the present invention;

FIG. 3 is a view of an embodiment of the lottery server of FIG. 2;

FIG. 4 is a view of an embodiment of the player device of FIG. 2;

FIG. 5 is a view of an embodiment of the player database of FIG. 3;

FIG. 6 is a view of an embodiment of the automated session database of FIG. 3;

FIG. 7 is a view of an embodiment of the player device database of FIG. 3;

FIGS. 8A and 8B are a flow diagram of a method in accordance with an embodiment of the present invention; and

FIG. 9 is a flow diagram of a method in accordance with an embodiment of the present invention, illustrating one example of termination of automated play.

### DETAILED DESCRIPTION

In the following description, reference is made to the accompanying drawings that form a part of the present disclosure, and in which are shown, by way of illustration, specific embodiments of the invention. These embodiments are described in sufficient detail to enable those skilled in the art to practice the invention, and it is to be understood that other embodiments may be utilized and that structural, logical, software, electrical and other changes may be made without departing from the scope of the present invention. The present disclosure is, therefore, not to be taken in a limiting sense. The present disclosure is neither a literal description of all embodiments of the invention nor a listing of features of the invention that must be present in all embodiments.

Numerous embodiments are described in this patent application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with various modifications and alterations. Although particular features of the present invention may be described with reference to one or more particular embodiments or figures, it should be understood that such features are not limited to usage in the one or more particular embodiments or figures with reference to which they are described.

The terms “an embodiment”, “embodiment”, “embodiments”, “the embodiment”, “the embodiments”, “an embodiment”, “some embodiments”, and “one embodiment” mean “one or more (but not all) embodiments of the present invention(s)” unless expressly specified otherwise.

The terms “including”, “comprising” and variations thereof mean “including but not limited to”, unless expressly specified otherwise. The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The terms “a”, “an” and “the” mean “one or more”, unless expressly specified otherwise. The term “plurality” means “two or more,” unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term “method” or a like term. Accordingly, any reference in a claim to a “step” or “steps” of a method is deemed to have sufficient antecedent basis.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the described databases may, in a known manner, be stored locally or remotely from a device that accesses data in such a database.

Various embodiments of the present invention are described herein with reference to the accompanying drawings. The leftmost digit(s) of a reference numeral typically identifies the figure in which the reference numeral first appears.

According to one embodiment of the present invention, an automated play parameter associated with a player is determined. For example, the automated play parameter may be received from the player or from a player device. The automated play parameter may be associated with a play frequency, a wager amount, and/or any other parameter. For example, the automated play parameter may be associated with a predetermined period of time (e.g., one ticket per hour), a predetermined event (e.g., one ticket each time the player accesses a Web site), and/or a predetermined amount (e.g., one ticket per minute until an amount of funds associated with the player falls below $10.00).

According to one or more embodiments, lottery information is provided (e.g., to the player or to a player device) based on the automated play parameter. For example, an electronic “scratch-off” type ticket may be delivered to a player via e-mail once per hour during his or her workday. According to another embodiment, a lottery device or a player device may also automatically play the lottery ticket for the player (e.g., by “scratching” the electronic ticket to reveal an outcome).

According to at least one embodiment, a limiting criterion of lottery play is received. Automated play of a lottery gaming device is initiated, and the automated play of the lottery gaming device is terminated upon occurrence of the limiting criterion. For example, automated play of the lottery gaming device may be terminated when the player has accumulated winnings of at least $10.00.

Furthermore, it is an advantage of at least some embodiments of the present invention that an instant lottery game may be presented in an electronically-presented graphical form, thus allowing for dynamic configuration of the representative value and corresponding parameters associated with each outcome sequence, player wager, automated player parameters, etc.

According to some embodiments, a plurality of player devices may be operatively in communication with a lottery device. As used herein, the term “player device” may encompass any computing device operable by a player. For example, a player device may comprise any one or more of a personal computer, a personal digital assistant (PDA), a cellular telephone, a two-way pager or the like. In one example, a player device is a device operable to display electronically represented instant lottery games that may be automatically played. Additionally, the player device may be operative to execute two-way data communications with the lottery device. Such communications may be facilitated by way of a computer network (e.g., the World Wide Web), the Internet, a local area network, a proprietary network (e.g., a network operated by GTECH Corp.), postal mail, or any combination thereof or equivalents thereto. In accordance with one or more embodiments of the present invention, one or more player devices may be located remotely from the lottery device, for example, at a home of a player, at a lottery retailer, etc.

According to some embodiments of the present invention, a lottery device may comprise a computing device, such as a Web server, operated by, on behalf of, or in conjunction with, a lottery authority (e.g., a state lottery authority). A lottery device may comprise any computing device operable to execute electronically represented instant lottery games in accordance one or more methods of the present invention (e.g., in an automated fashion). For example, a lottery device may be embodied as a personal computer, operative via one or more microprocessors, such as the Intel® Pentium® microprocessor. In addition to processing capability, the lottery device may comprise memory capability such as that afforded by one or more of a random access memory (RAM) and/or read-only memory (ROM).

According to some embodiments, the lottery device may include a clock element operatively in communication with the processor and/or memory. In accordance with at least one embodiment of the present invention, the lottery device processor may utilize the clock element in order to ascertain if lottery information (e.g., an electronic lottery ticket) should be transmitted to a player device.

According to one embodiment, the lottery device may comprise one or more input and/or output devices, including, for example, a touch screen, a keyboard, a monitor, a mouse, etc. Other forms of input and/or output devices are known to those skilled in the art.

According to one embodiment the lottery device may include at least one communication device, operative to assist in data communications with the player device. For example, the communication device may comprise a modem, serial port, or the like, operative to facilitate two-way data communication between the player device and the lottery device.

The lottery device may comprise data storage capability such as that afforded by one or more of a hard disk, optical or magnetic media, etc. The data storage capability may function to store one or more databases along with a program operative to implement one or more methods of the present invention. The databases may function to store data relevant to one or more games executed in conjunction with the player device. For example, the automated play parameter database may function to store information regarding instant lottery game tickets played by a player.

According to at least one embodiment, such information is stored (instead or in addition) at the player device. For example, data may be securely stored in an encrypted format, whereby the data is seemingly indecipherable to the player. For a detailed explanation of various cryptographic algorithms and protocols that may be useful with one or more embodiments of the present invention, see the '398 patent.

According to at least one embodiment of the present invention, the lottery device may be operable to (i) receive an outcome sequence request from the player, (ii) determine an appropriate outcome sequence to be provided to the player, (iii) provide the outcome sequence to the player device, and (iv) execute an outcome redemption routine.

In accordance with at least one embodiment of the present invention, an appropriate outcome sequence may be provided to the player device in any one of several manners. For example, the lottery device may, in response to an outcome sequence request from a player device, provide either (i) a large outcome sequence, executable by the player device over the course of several game sessions, and/or (ii) a smaller outcome sequence, executable by the player device over a lesser number of game sessions (e.g., a single game session). For example, the lottery device may, upon receiving an initial outcome sequence, transmit and store a predetermined number of outcomes at the player device (e.g., by downloading the outcome sequence to the player device). Alternatively, the lottery device may provide a specific number of outcomes (i.e., a specific outcome sequence) to the player device in response to a received outcome sequence request, generated by the player device. For example, upon a player initially “registering” with the lottery device to play one or more electronically represented instant lottery games, the lottery device may provide a “block” of outcomes, that may subsequently be revealed by the player during the course of one or more gaming sessions. Alternatively, or in addition, the lottery device may simply provide a specific number of outcomes to the player device based on a received outcome sequence request

According to some embodiments, the player device may contain similar elements and/or perform similar functions, as those described herein with respect to the lottery device.

According to at least one embodiment of the present invention, an automated play parameter database stores information used to provide lottery information to a player. A player identifier may be, for example, an alphanumeric code associated with a player who has registered with a lottery provider.

According to one or more embodiments of the present invention, one or more automated play parameters indicate how lottery information should be automatically provided to the player. For example, a lottery ticket may be delivered to a player at predetermined times or upon the occurrence of predetermined events (e.g., each time a player accesses his or her e-mail). Other information may also determine the automatic delivery of lottery information (e.g., information associated with unplayed lottery tickets, or with the results of lottery tickets that have been played for the player). For example, the lottery device may terminate the automated play of lottery tickets when a player's account falls below, reaches, or rises above a threshold amount.

According to one embodiment of the present invention, a method is provided that may be performed by either the player device or the lottery device. An automated play parameter associated with a player is determined, and lottery information is provided in accordance with the automated play parameter. In this way, a player is able to initiate an automated play or “auto-play” feature. Thus, some embodiments of the present invention allow lottery players to initiate an auto-play feature. A player may specify an amount to bet per play, a play frequency, and/or other rules. For example, the player may wish to autoplay one $0.10 ticket per hour. The player may further specify that he wishes to terminate play if his account balance drops below $5 or exceeds $40.

According to one embodiment of the present invention, “instant replays” of highlights may be provided to a player (e.g., when the player checks the lottery game progression during auto-play).

According to one embodiment of the present invention, an automated program may be allowed to make some choices at certain times, such as bet in certain game situations, decide how much to bet, etc.

According to one embodiment, a friend could play for a player.

According to one embodiment, a first player could couple or otherwise associate his or her play with a second player, so that outcomes that are provided to the second player are the same as or are proportional to outcomes provided to the first player.

According to one embodiment, incentives may be provided, such as better odds or higher pay scales if a player does not have very constraining maximum/minimum constraints on his auto-play bets. Such incentives may be appealing to customers who prefer risk.

According to one embodiment, relatively complex rules for play may be implemented. For example, a player may specify that if he wins over $5 on auto-play, then he wants to double down on the next ticket.

One or more embodiments of the present invention provide for a method comprising determining an automated play parameter associated with a player, and providing lottery information in accordance with the automated player parameter. According to one embodiment, the determining comprises receiving the automated play parameter from the player. According to another embodiment, the determining comprises receiving the automated play parameter from a player device. According to another embodiment, the automated play parameter is associated with at least one of the following types of parameters: (i) a predetermined period of time, (ii) a predetermined event, and (iii) a predetermined amount. According to another embodiment, the providing of the lottery information comprises delivering a lottery ticket outcome to a player device. According to another embodiment, the providing of the lottery information comprises displaying a lottery ticket outcome to the player.

One or more embodiments of the present invention provide for systems and methods that may be useful for facilitating play of electronically represented instant lottery games.

One or more embodiments of the present invention provide for a method comprising receiving a limiting criterion of lottery play, initiating automated play of a lottery gaming device, and terminating automated play of the lottery gaming device upon occurrence of the limiting criterion.

A method according to one embodiment of the present invention provides for: receiving data indicating a request by a player for an automated session, in which the automated session comprises a plurality of lottery outcomes; determining at least one parameter associated with the automated session; determining at least one lottery outcome; and providing the at least one lottery outcome based on the at least one parameter.

Various embodiments of the present invention provide a method and apparatus for automated play of lottery games. According to one exemplary process, a player device and a lottery server (or other type of lottery device) are in communication with each other. Either the player device or the lottery server (or a combination thereof) performs a method of determining an automated play parameter associated with a player, and providing lottery information in accordance with the automated play parameter. In this way, a player may enjoy automated play of a lottery game (or games).

Various embodiments of the present invention include a lottery server and/or a player device operable to: receive data representing a limiting criterion of play, initiate automated play of a lottery game, and terminate automated play of the lottery game upon satisfaction or occurrence of the limiting criterion. In accordance with some embodiments, automated play of the lottery game may include repetitive play of the lottery game (e.g., until the limiting criterion is satisfied).

In certain instances, the limiting criteria may comprise the level of funds or credit available or initially authorized for play. For example, a limiting criterion may be satisfied when an account or an amount of credit associated with an automated play mode reaches a predefined level (e.g., the account or amount of credit reaches either zero or at least $50). Some embodiments of the present invention further provide for methods and apparatus for notifying a player when available credit is running low, permitting a player to increase the balance of an account or amount of credit, and/or remotely authorizing further funds to be available for continued play.

A method according to some embodiments of the present invention includes the step of initiating automated play at a player device. In such embodiments, automated play of the player device may occur when the player device is unattended by a player.

According to some embodiments, the method includes the steps of receiving a play option and automatically playing a lottery game according to the play option.

According to some embodiments of the present invention, a lottery device (e.g., a lottery server) includes a memory device having a player parameter selection stored therein and a processor in communication with the memory device. The processor is configured to initiate automated play of a lottery game until satisfaction of one or more limiting criterion of play.

Some embodiments of the present invention provide for determining an outcome of an automated play session that requires a decision by the player in order to determine a further outcome and/or payout, and holding the outcome for a later decision by the player. Alternatively, the outcome requiring a decision may be determined in accordance with a parameter associated with the automated play session.

Some embodiments of the present invention further provide for maintaining an audit trail for a lottery server, a player device, and/or the outcomes of one or more lottery games (e.g., with respect to a session of automated play).

According to various embodiments of the present invention, a player provides player identifying information and player parameter selections to a lottery server and/or a player device. The lottery server and/or player device stores the player parameter selections and proceeds to initiate automated play of a lottery game or of multiple lottery games (e.g., in accordance with the player parameter selections).

According to various embodiments, the player identifying information and player parameter selections may be entered at a player device. The player device may store the information and selections and/or transmit the information and selections to a lottery server. According to various embodiments, the player device may initiate automated play.

Such automated play may occur while the player device is unattended by the player. In some embodiments, remote communications with the player permit the player engaged in automated play both to enjoy the ongoing play, and to alter any pre-established, limiting criteria, for example relating to funding, by making appropriate adjustments during the course of automated play. In various embodiments of the present invention, such adjustments may be made via a player device. Some limitations or criteria may also be altered remotely, for example, through a telephone call or appropriate communication to the lottery server or, for example, to personnel operating the lottery server. An automated play session may terminate or be altered upon occurrence of a limiting criterion or upon the termination or alteration of the automated play session by the player.

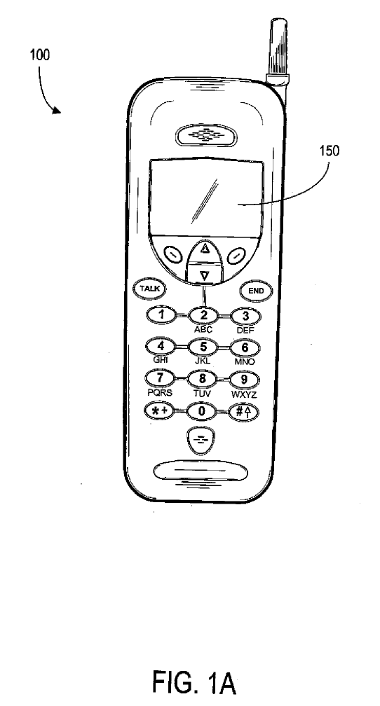

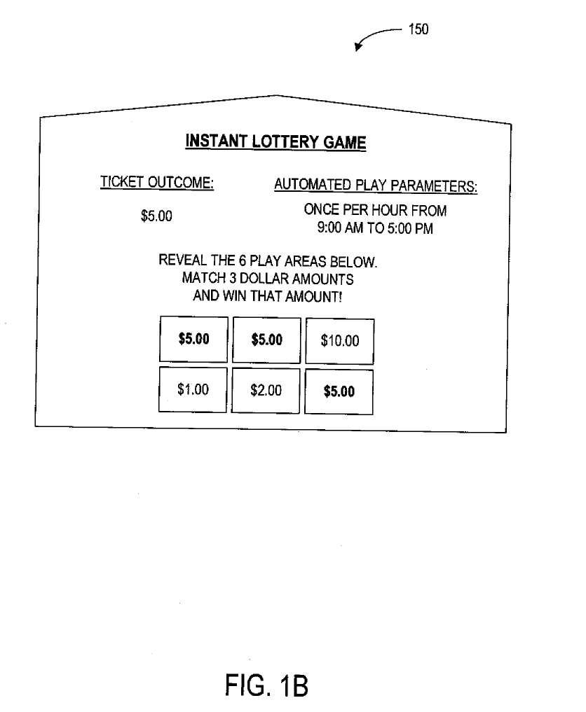

Referring now to FIG. 1A, a cellular telephone 100 according to one exemplary embodiment of the present invention is shown. The telephone 100 has a game display 150 capable of displaying lottery information.

With reference to FIG. 1B, the game display 150 depicts an example of an instant lottery game. A player playing the instant lottery game is instructed to reveal the six play areas displayed. If three winning amounts are matched, the player wins that amount (e.g., the instant lottery game shown in FIG. 1B results in a ticket outcome or payout of $5.00). The game display 150 indicates that the player has arranged to have one instant lottery game automatically delivered (and/or automatically displayed) each hour from 9:00 AM to 5:00 PM (e.g., without further input or request from the player) via cellular telephone 100.

The play areas may be revealed in response to the player's input, for example, by using the keypad of the cellular telephone 100, or, alternatively or in addition, by voice command. Alternatively, the play areas may be revealed automatically by the cellular telephone 100. According to one embodiment, the cellular telephone may reveal the play areas automatically in response to a signal from a lottery server.

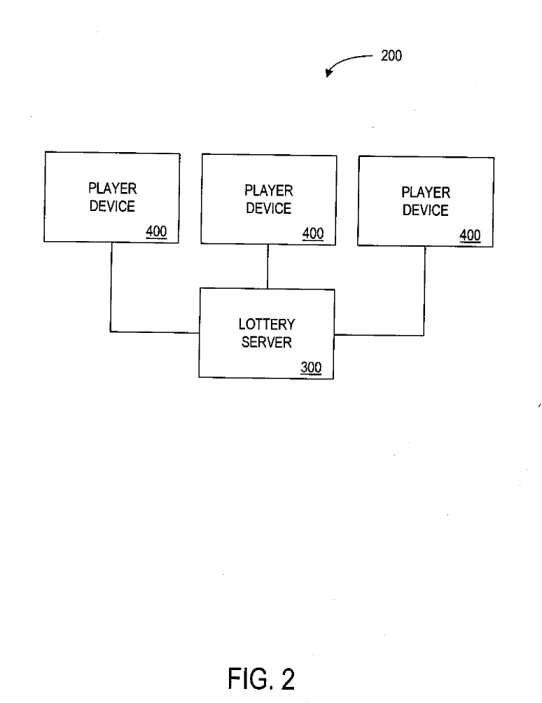

With reference to FIG. 2, a system 200 according to one embodiment of the present invention is shown. In general, the system 200 comprises a lottery server 300 in communication with a plurality of player devices 400. Player device 400 (e.g., a pager, a personal computer, a handheld display device, a PDA, a set-top display device, or a cellular telephone) preferably is operable to provide sufficient information to permit the player to follow and enjoy the play, and in some cases to authorize necessary or desired changes in the play. Although three player devices 400 are depicted in the exemplary system of FIG. 2, it will be understood that any number of one or more player devices 400 may be in communication with the lottery server 300.

As will be described in greater detail below, in some embodiments the player device 400 may be operable to communicate information identifying a player and/or player parameter selections to the lottery server 300 and/or may be operable to receive various types of information from the lottery server 300. The lottery server 300 may comprise a computer device, such as a Web server, operated by, on behalf of, or in conjunction with, a lottery authority. The lottery server 300 determines lottery outcome data and communicates instructions and lottery information, including the lottery outcome data, to the player device(s) 400. Although various embodiments of the present invention are described herein with respect to a lottery server or Web server for providing lottery information (among other functions), it will be understood that various other types of computing devices may be used as lottery devices.

Communications among the lottery server 300 and the player devices 400 may be facilitated by way of a computer network, such as the World Wide Web, the Internet, a local area network (LAN), a proprietary network, postal mail, or any combination thereof. In accordance with some embodiments of the present invention, a plurality of player devices 400 may be located remotely from the lottery server 300, for example, at a home of a player and/or at a lottery agent.

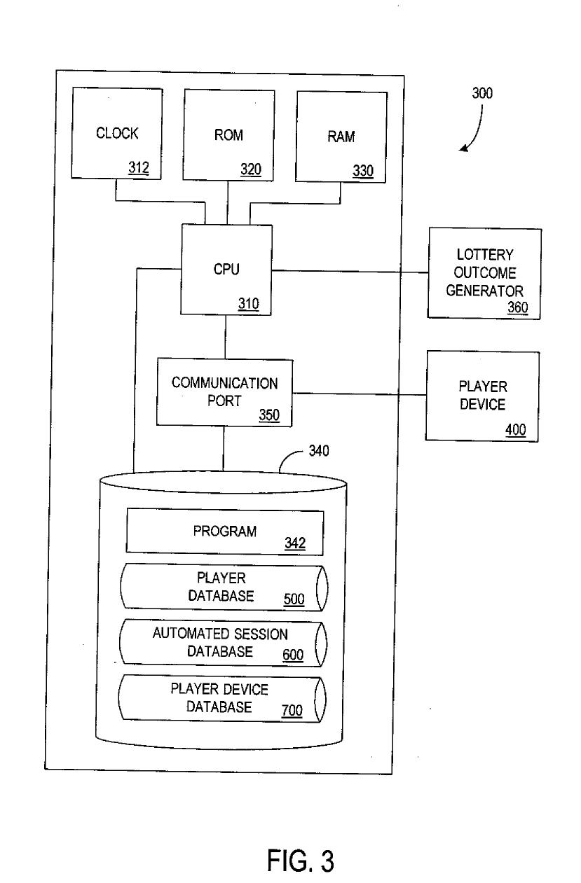

With reference to FIG. 3, the lottery server 300 is described in greater detail. Lottery server 300 may comprise any computing device operable to execute electronically represented instant lottery games in accordance with one or more methods of the present invention. Lottery server 300 has a Central Processing Unit (CPU) 310. The CPU 310, which has an optional clock 312 associated therewith, may execute instructions of a program stored in Read Only Memory (ROM) 320 or other type of memory. During execution of the program instructions, the CPU 310 may temporarily store information in Random Access Memory (RAM) 330.

Additionally, the lottery server 300 may comprise a data storage device 340, for storing a program 342, a player database 500, an automated session database 600, and a player device database 700. In general, the program 342 directs the CPU 310 to perform certain functions of the present invention, and in particular, various methods described herein. As discussed in detail below, the player database 500, the automated session database 600, and the player device database 700 store information related to player identification, automated lottery game play, and remote communication to the player device(s) 400, respectively.

In order to communicate with a player device 400, the lottery server 300 may include a communication port 350 (e.g., for communicating directly or indirectly via an electronic network). The communication port 350 may be coupled to both the CPU 310 and the data storage device 340. Thus, the CPU 310 can control the communication port 350 to receive information from the data storage device 340 and transmit the information to the player device 400. Information may also be received from the player device 400 via communication port 350. Note that the communication path between the communication port 350 and the player device 400 need not be hardwired.

As noted above, the player device 400 preferably comprises one or more devices such as a personal computer, a pager, a digital media player (e.g., a CD player, a DVD player), a handheld device including a display (e.g., a PDA), a set-top device, a smart card, and/or a cellular telephone or smartphone, and may employ either (or a combination of) wired and/or wireless communication. In some embodiments, the player device may comprise a flash- and/or hard-drive based device for playing games, displaying audio files, displaying image files, and/or displaying video files. Some examples of such devices include an iPod™ or iPod photo™ player by Apple Corp., an H10™ media player by iriver, and a Sony® PSP™ handheld device.

In some embodiments, the player device 400 comprises at least one communication device (e.g., a cellular telephone, a pager) operable to facilitate direct and/or indirect one- or two-way communication with the lottery server 300. In some embodiments, the player device 400 may be operable to receive communications (e.g., lottery information) from the lottery server 300 indirectly and/or via channels or networks that are not solely electronic, such as via postal mail, by a purchase from a retail establishment, or as provided by a player to the player device using computer-readable media such as CD-ROMs, DVDs, or flash-based memory (e.g., a USB flash drive).

In accordance with one embodiment, the lottery server 300 may generate or otherwise determine a set of lottery outcomes and/or payouts. A player may be allowed to subsequently determine and/or view the outcomes via a player device 400. In accordance with such an embodiment, the lottery server 300 may be operable to record or otherwise store all or a portion of the determined outcomes on one or more portable media and/or memory device(s) (e.g., CD-ROM, DVD, proprietary memory, etc.). The player device 400 may be operable to receive stored outcomes or other lottery information (e.g., via a CD-ROM drive) and to render one or more lottery outcomes and/or payouts in accordance with an automated session.

For example, the provision of one or more lottery outcomes and/or payouts from the lottery server 300 to the player device 400 may entail the retail sale of pre-recorded media and/or software, which may be viewed or other wise presented to the player via a player device 400. Such an embodiment may be beneficial, for example, where no network communication is provided, permitted or desired between the player devices 300 and the lottery server 400.

Lastly, also in communication with the CPU 310 is a lottery outcome generator 360. Under control of a program stored, for example, in storage device 340 or ROM 320, the CPU 310 preferably employs the lottery outcome generator 360 to generate and/or receive lottery outcome information. Alternatively, the CPU 310 may be controlled by, or responsive to, for example, a signal from the player device 400.

Lottery outcome generator 360 may include one or more random number generator(s) for use in generating lottery outcomes. Alternatively, the lottery outcome generator 360 may operate to generate and/or store a randomly distributed sequence of predetermined outcomes. Such outcomes may be created by or on behalf of a lottery authority in accordance with the needs of the lottery authority. For example, the outcomes may be generated such that the total payouts resultant of such outcomes is equal to a predetermined percentage of the total wager required to play each outcome.

According to some alternative embodiments, the CPU 310 may generate and/or receive a random number (e.g., using a random number generator), look up the generated random number in a stored table (not shown) and identify a corresponding outcome (e.g., a set of six symbols with three of the symbols matching, as displayed in FIG. 1). Based on the identified outcome, the CPU 310 may determine an appropriate payout (e.g., in a stored payout table). Alternatively, the CPU 310 may determine the payout based directly upon the generated random number.

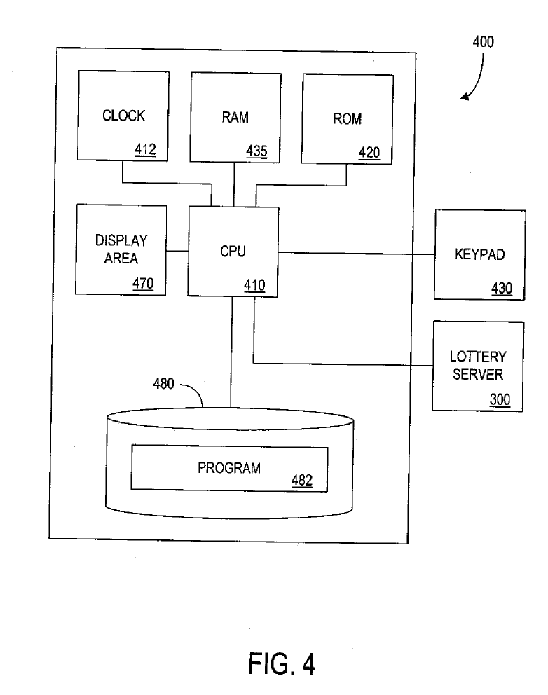

With reference to FIG. 4, the player device 400 comprises a Central Processing Unit (CPU) 410 and an optional clock 412. The CPU 410 may execute instructions of a program stored in memory (e.g., read-only memory (ROM) 420).

The exemplary player device 400 also includes a display area 470 and a keypad 430. In operation, as discussed below, the player device 400 may display a message prompting the player to enter player parameter selections. In accordance with such an embodiment, the player enters the player parameter selections via the keypad 430. In an alternative embodiment, a player enters the player parameter selections via voice commands and/or via the display area 470, which may include a touch screen.

With respect to gaming operations, under control of a program (e.g., program 482 stored in a storage device 480 and/or ROM 420), the CPU 410 may determine an automated play parameter associated with the player. For example, the player may input an indication of an automated player parameter, or, alternatively, the player device may store an indication of one or more available automated player parameters in, for example, storage device 480. For example, the player device 400 and/or lottery server 300 may provide a graphical menu of available player parameters for selection by a player. Such parameters may then be used in providing one or more lottery outcomes in accordance with an automated play session, as described herein. Thus, the player device 400 may provide lottery information in accordance with the automated play parameter. For example, as discussed in greater detail below, a sequence of lottery outcome data may be received from lottery server 300 and/or lottery outcome generator 360 and stored, for example, in storage device 480. Player device 400 may then display lottery information (e.g., via display area 470) in accordance with the automated play parameter by, for example, revealing a game (or game result) in accordance with a player-defined schedule (e.g., once every hour). Alternatively, or in addition, the CPU 410 may be controlled by, or responsive to, for example, a stored program or a signal from the lottery server 300. Thus, information and instructions may be communicated between the lottery server 300 and player device 400.

Embodiments of the present invention may be implemented using one or more databases. It should be noted that although the example embodiments depicted in FIGS. 3 and 4 include a number of particular databases stored in the respective exemplary devices, other database arrangements may be used which would still be in keeping with the spirit and scope of the present invention. In other words, the present invention could be implemented using any number of different database files or data structures, as opposed to those depicted in FIGS. 3-7. In one embodiment, the information of one or more of the databases of a lottery server 300 (FIG. 3) may be stored, alternatively or in addition, in the data storage device 480 of a player device 400 (FIG. 4), and vice versa. Further, the individual database files could be stored on different servers (e.g., located on different storage devices in different geographic locations, such as on a peripheral device). Likewise, any programs useful for implementing one or more embodiments of the present invention could also be located remotely from the data storage devices and/or on another server

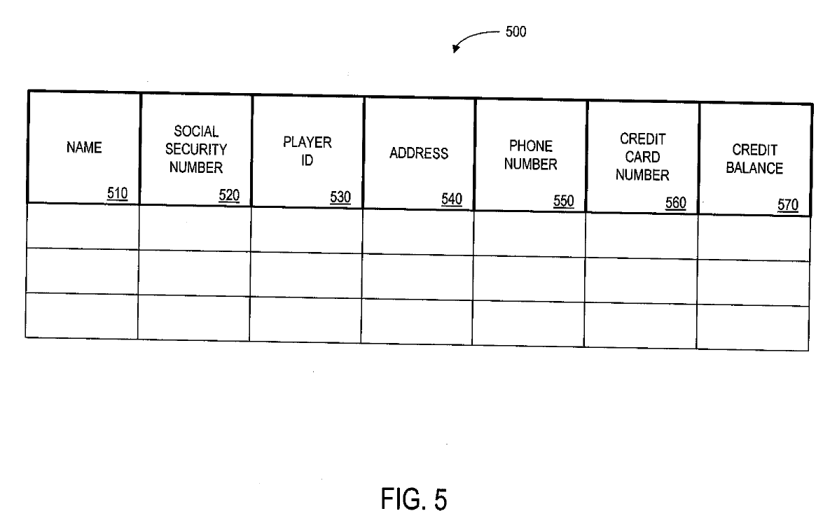

The player database 500, as shown in one exemplary embodiment in FIG. 5, may include multiple records having multiple fields for storing data. Specifically, the player database 500 comprises multiple records, each record being associated with a particular player, as identified by a player identification (ID) code. The fields within each record may include, for example: name 510, social security number 520, player ID 530, address 540, telephone number 550, credit card number 560, and credit balance 570. Thus, having information related to one field, such as player ID 530, allows the lottery server 300 to retrieve or access further information stored in the other fields of that player's record.

It is to be understood that none of these identifying fields, nor the illustrated design of the player database 500, are absolutely necessary, but may be desirable for particular embodiments and applications of the present invention. Specifically, the name 510, social security number 520, player ID 530, address 540, telephone number 550, credit card number 560, and credit balance 570 fields are merely representative of additional information that may be stored and used for other purposes. For example, in an alternative embodiment, credit card number 560 may be used for billing purposes and social security number 520 may be used to generate tax forms when a player wins a payout over a given amount. In another example, only the player's name 510, player ID 530 and credit balance 570 may be necessary or desirable for a particular application.

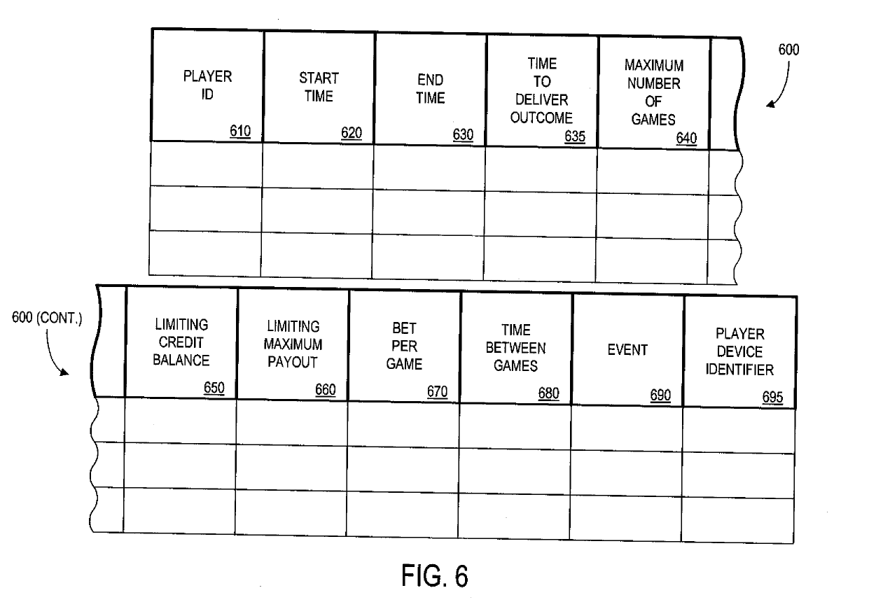

The automated session database 600, as shown in FIG. 6, comprises multiple records, each record pertaining to an automated play session of a particular player, as identified by the player ID. Consequently, one field in each record is the player ID field 610. Other fields include: start time 620, end time 630, time to deliver outcome 635, maximum number of games 640, limiting credit balance 650, limiting maximum payout 660, bet per game 670, time between games 680, event 690, and player device identifier 695. As will be apparent to one of ordinary skill in the art, since both the player database 500 and the automated session database 600 include a player ID field, 530 and 610, respectively, the system 200 can correlate any information stored in the player database 500, corresponding to a particular player, with any information stored in the automated session database 600, corresponding to that same player.

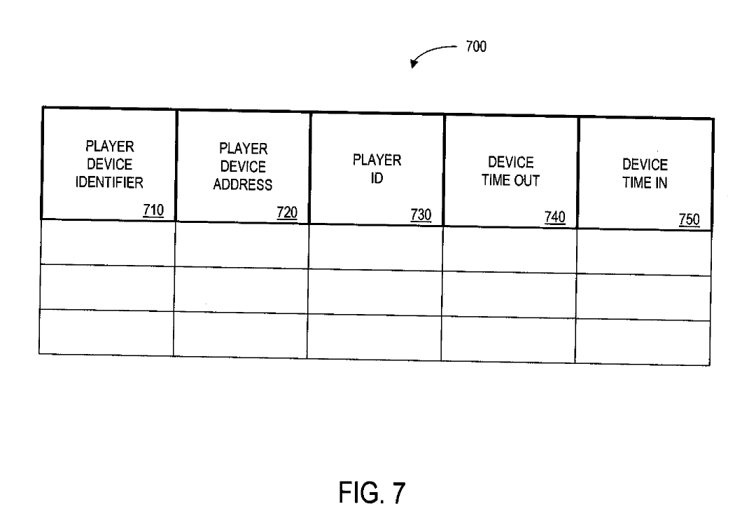

The player device database 700, as shown in FIG. 7, includes multiple records, each record pertaining to a different player device 400 as identified by a player device identifier (e.g., an alphanumeric identifier unique to a particular player device) as stored in the player device identifier field 710. The additional fields in each record may include, e.g.: a player device address 720 for storing information about one or more addresses that may be used to communicate with the player device, player ID 730, device time out 740, and device time in 750. Because the player device database 700 and the automated session database 600 each include a player device identifier field 710 and 695, respectively, information may be correlated between the two databases. In some embodiments, a player device address 720 (e.g., an Internet protocol address) may be used as the player device identifier 710, in which case it may not be necessary or desirable to maintain separate fields for both the player device identifier 710 and the player device address 720.

Furthermore, because the player device database 700, like the automated session database 600 and the player database 500, contains a player ID field 730, the system 200 can correlate information contained within these three databases 500, 600, 700 for a particular player, as identified by the player ID.

According to one or more embodiments of the present invention, an establishment, retailer, and/or lottery authority may distribute player devices and/or may make player devices available for players to rent or borrow. In such an embodiment, player device database 700 may be used to inventory the player devices 400. For example, the information stored in the device time out field 740 may represent the time and/or date at which a player received a player device 400 from, for example, a lottery agent, and the device time in 750 represents the time the player device 400 was returned to, for example, the lottery agent. Having such information, the lottery server 300 (and/or a lottery agent or other provider of a player device) may, at any given time, search the player device database 700 and determine which player devices 400 are presently in use. Furthermore, for any player device 400 that has been out for more than a given period, the lottery server 300 may determine which player, based upon the player ID number in field 730, last used the device 400. Moreover, based on the player ID number, the server 300 can obtain the information necessary to contact that player from that player's record in the player database 500.

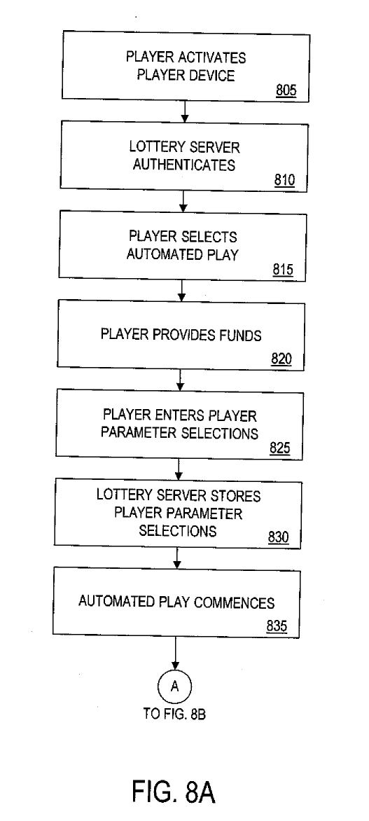

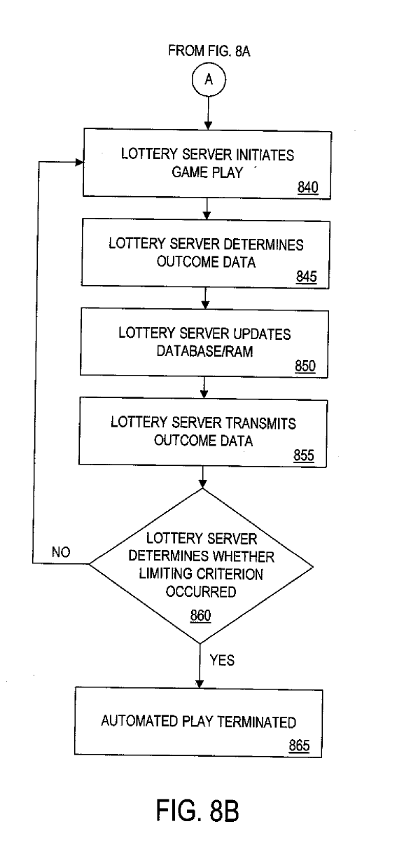

As will be understood by those skilled in the art, the ultimate goal of most lottery players is to obtain a winning outcome or large payout. The enjoyment of the play, as well as the ability to maximize the chance of winning a large payout, is increased by more play. Play can be increased by playing longer, by playing more frequently, and/or by playing faster. As will be appreciated from a consideration of the exemplary process described below, some embodiments of the present invention permit both increased duration and speed of play. Some examples of the operation of the system 200 will now be described in greater detail with reference to automated play process 800 of FIGS. 8A and 8B, and continuing reference to FIGS. 1-7. It is to be understood that programs of the lottery server 300 and/or of the player device 400 may be used, alone or in combination, to provide the functions described below. For instance, although some steps are described in the following example as being performed by either the lottery server 300 or the player device 400, it will be understood that either device may be operable to perform the described function. For example, rather than a player device transmitting player parameter selections to a lottery server 300, the lottery server 300 may be operable to determine one or more such parameters (e.g., based on stored information about a player, or based on default parameters).

As shown at step 805, the lottery player first activates player device 400. Player device 400 then proceeds to determine player identifier information. Player identifier information may be stored, for example, in storage device 480. Alternatively, the player may input the player identifier information. Typically, the player identifier information, namely the players name and the player ID, are communicated from the player device 400 to the lottery server 300. In other embodiments, the player device 400 may simply transmit its player device identifier to lottery server 300. For example, where the player device 400 is embodied as a cellular telephone, the lottery server 300 may utilize an automatic number identification (ANI) system in order to determine the player device identifier and/or player device address. The lottery server 300 may then retrieve player identifier information by referencing the player device identifier field 710 (or player device address 720) of the player device database 700 and determining the corresponding player ID 730.

Upon receiving or otherwise determining the information identifying the player, the lottery server 300 may operate to authenticate the information. This step, depicted as step 810, may include the lottery server 300 searching the player database 500 for a record containing the player name and player ID received in the appropriate fields 510 and 530, respectively. Alternatively, or in addition, the lottery server 300 may authenticate player information via the receipt of a player identifier and player password, access code or personal identification number (PIN). Once the lottery server 300 authenticates the player identifying information at step 810, the server 300 may transmit or otherwise output an indication to the player device 400 acknowledging such authentication.

At step 815, the player selects or otherwise requests automated lottery play. According to various embodiments of the present invention, the player may choose to select automated lottery play after receiving an offer of a reward in exchange for the player participating in an automated play session. A reward might be, for example, a bonus payout an improved payout schedule, a gift certificate, free plays, or the like.

In step 820, the player provides funds for automated play. For example, the player device 400 may prompt the player in order to authorize the use of funds during or prior to the automated play session. In another example, the player uses player device 400 to authorize an amount of funds for lottery play by, for example, providing a credit card number and the amount of funds the player wishes to have credited to his game account. The player device 400 then transmits a signal to the lottery server 300 indicating the credit card number and/or the amount of funds deposited by the player. In response, the lottery server 300 accesses the record in the player database 500 corresponding to the particular player and increments the credit balance field 570 in accordance with the amount of funds deposited.

In yet another alternative embodiment, the player, prior to initiating an automated play session, deposits a certain amount of funds at a lottery agent. The lottery agent accesses the record in the player database 500 corresponding to the player's ID. The agent then increments the credit balance field 570 by the amount of funds deposited.

In step 825, the player enters one or more player parameter selections. In one example, the lottery server 300 may transmit a signal to the player device 400 causing the player device 400 to display a prompt on the display area 470 requesting that the player enter one or more player parameter selection(s). As noted above, in one embodiment the player may enter the player parameter selection(s) via keypad 430. In an alternative embodiment, the player enters the player parameter selection via a touch screen of the display area 470. In another embodiment, the player parameter selections are previously stored in a record in the automated session database 600 as identified by the particular players player ID in field 510. Alternatively, the player may enter the player parameter selections via voice commands to player device 400.

Player parameter selections may include play options and/or limiting criteria of play. Play options, as used herein, include any information used to define automated play. For example, play options may include the bet per game and time between games, as stored in fields 670 and 680 of the automated session database 600. Other play options may include, for example, the type(s) of lottery game(s) to be played (e.g., a preferred game format), a preferred strategy or default decision for play (e.g., which location(s) to scratch), preference for reinvesting any winnings (or not), a time for an outcome to be provided, or an event that triggers the provision of an outcome (e.g., every time the New York Yankees play a baseball game). For example, a player might request an automated play session including only games that had produced the most (or, alternatively, the fewest) wins in the last hour.

In accordance with some embodiments, various aspects of an automated play session may comprise enabling the player device 400 to reveal a series of outcomes and/or payouts in accordance with one or more player-preferred format(s). According to such embodiments, numerous outcomes and/or payouts may be transmitted or loaded onto the player device 400 for subsequent output in accordance with a sound and/or display format selected or otherwise specified by a player. For example, a player having requested the output of a total of twenty outcomes may direct the player device 400 to output one-half of the twenty outcomes in accordance with a first format (e.g., an electronic representation of a physical scratch-off game) and the other half in accordance with a second format (e.g., an electronic representation of a blackjack game). Thus, the player device 400 and/or the lottery server 300 may include means for receiving an outcome, lottery result and/or payout amount and subsequently rendering the outcome and/or payout in a manner or format preferred by the player.

Play options may be used by the player device 400 or by the lottery server 300 to determine how the player wants lottery information delivered. For example, a player may desire an electronic “scratch-off” type lottery ticket to be delivered to the player via e-mail once per hour during the workday. According to another embodiment, the player device 400 or the lottery server 300 may automatically play the lottery ticket for the player, for example, by revealing or otherwise determining an outcome of the electronic ticket.

A limiting criterion, on the other hand, is any information that may define the beginning or end of an automated play session. For example, limiting criteria include: start time, end time, number of games, credit balance, total losses, total winnings, occurrence of an event (e.g., start/end a session if the New York Yankees make the playoffs), and limiting maximum payout. Preferably, the expiration of all available credits/funding for playing will, unless other arrangements are made in advance with the lottery authority, constitute a limiting criterion of play. Similarly, the player may define a specific winning credit value or total account balance as a limiting criterion of play (e.g., stop playing if a credit of one thousand dollars is ever registered).

Once the player device 400 determines the player parameter selections, the player device 400 preferably transmits the information to lottery server 300. For example, if the player device 400 is a handheld or desktop computer connected to the Internet and the player inputs information via a form on a Web page, the player device 400 may transmit the received information via the Internet to the lottery server 300. The lottery server 300, as shown in step 830, proceeds to store the player parameter selections (e.g., in the appropriate fields in the automated session database 600).

In addition to storing the player parameter selections, the lottery server 300 may assign an address in RAM 330 to keep current totals of actual limiting values. An actual limiting value is a value that corresponds to a limiting criterion of play. More specifically, an actual limiting value is the actual, current total of a criterion value necessary to determine whether any of the limiting criteria of play have occurred.

For example, in one embodiment, the lottery server 300 assigns an address in RAM 330 to store the number of outcomes or games that actually occur during automated play. Additionally, the server 300 assigns an address in RAM 330 to store the actual amount of losses or winnings during automated play. Both the actual number of outcomes and the actual amount of winnings or losses may be actual limiting values.

Furthermore, the current credit balance, which may be stored in RAM 330, may also be an actual limiting value. As described below with reference to steps 845, 850 and 860, preferably these actual limiting values are updated during automated play and used to determine whether a limiting criterion has occurred.

The lottery server 300 may also assign an address in RAM 330 to store a time value corresponding to the play option of time between games 680.

Next, in step 835, the automated play session commences. In one embodiment of the present invention, the commencement of automated play includes the lottery server 300 transmitting locking data to the player device 400. The locking data may be a signal that prevents a player from initiating a manual play of the player device 400.

The lottery server 300 need not transmit locking data. If so, player device 400 is not locked and may be used by any player (including the player for whom automated play has commenced).

Automated play may proceed in various ways, in one example, the lottery server 300 may initiate automated play of a lottery game (or games), as shown in step 840 (FIG. 5B). For instance, if the player has entered a start time 620 as a player parameter selection, the lottery server 300 may search the automated session database 600 and compare the time from the clock 312 to the values stored in the start time field 620 and the end time field 630. If the internal clock time is equal to or greater than the value stored in the start time field 620 and less than the value stored in the end time field 630 (if such a value exists), then the lottery server 300 initiates automated play.

Alternatively, the player may choose to begin automated play immediately upon entering the player parameter selections other than a start time 620.

In step 845, the lottery server 300 determines outcome data. Outcome data, as used herein, means any information describing the outcome of a game in one embodiment, outcome data includes a combination of numbers and/or values as well as the corresponding payout or loss for a given play.

According to various embodiments of the present invention, once the lottery server 300 determines the outcome data, it accesses the automated session database 600 to determine the bet per game 670 for the particular player. As indicated in step 850, the lottery server 300 may update one or more databases and/or information stored in RAM (e.g., related to limiting criteria of play). For example, the lottery server 300 may access the player database 500 to update the credit balance field 570 in the player's record. The credit balance field 570 is decreased by the bet per game amount and increased by the payout, if any. The credit balance may be updated at once (e.g., when the automated play session begins), periodically (e.g., upon each generation of an outcome, upon each transmission of information about an outcome to the player device, upon each revealing of an outcome to a player), or at any time (e.g., after a session is completed).

In various embodiments, lottery server 300 stores outcome data in conjunction with information identifying the player associated with the outcome. This allows subsequent audits to account for the fact that although one outcome was generated, a corresponding revenue stream may be associated with more than one player (e.g., each of two players may receive the same outcome). Alternatively, lottery server 300 may store the above information without the identities.

Once the lottery server 300 receives or otherwise determines the outcome data, the lottery server 300 preferably also updates the actual limiting criteria stored in RAM 330, as needed. For example, the number of games value may be incremented by one and the total losses/winnings value may be changed to reflect the results of the previous game.

In various embodiments of the present invention, as discussed above, a player may indicate a preference for how often information about lottery games are provided to him. In one example, the lottery server 300 may store the time it proceeds to step 855, as indicated by clock 312, as the time value corresponding to the time between games 680. The lottery server 300 may use this time value to determine the speed of play. Each subsequent time the system 200 performs the operations of step 850, the lottery server 300 also determines whether, in light of the time between games 680, it must delay before continuing to proceed (e.g., before transmitting outcome data in accordance with player preferences). Specifically, the lottery server 300 may retrieve the time between games 680 and the previously stored time value. The lottery server 300 would then only proceed to step 855 when the current time, as indicated by the clock 312, equals the sum of the time between games 680 and the previously stored time value. The server 300 stores the time it proceeds to step 855 as the new time value.

It is anticipated that a player having only (or desiring only) a limited time to play and/or a small amount of funds available will enter the minimum allowed time (e.g., “zero”) as the time between games 680. If such a value is received, the system 200 proceeds to continuously generate outcome data without delay, or with a minimal amount of time between generated outcomes, until a limiting criterion of play occurs. For example, the player enters the minimum allowed time as the time between games 680 in step 825 and likely remains at the player device 400 to watch the player device 400 rapidly display game after game until, for example, the player is out of funds or wins a payout.

In various alternative embodiments of the present invention, the lottery server 300 compares generated outcome data with a player's session parameters to determine if the game corresponding to the generated outcome data should be included as a game in the player's automated play session. For example, a player may choose to include all games from a particular type of lottery game in his automated play session.

Once the lottery server 300 determines the outcome data (step 845) and updates the databases (as necessary or desirable) (step 850), in step 855 the lottery server 300 transmits or otherwise provides the results of the play to the remote player device 400. The results communicated in step 855 to the player device 400 may include, for example, the determined sequence of numbers or values, the payout of a particular game, the player's current credit balance 570, and any other information stored or generated by the system 200.

Alternatively, the results may be stored by the lottery server 300 and communicated, for example, at a specific time, periodically, upon the player's request, or in accordance with a player's selection parameters. Similarly, the results, once received by the player device 400, may be stored and displayed, for example, at a specific time, periodically, upon the players request, or in accordance with a player's selection parameters.

According to one embodiment, the lottery server 300 may determine an outcome sequence, for example, in accordance with a player parameter or in response to a player request. The lottery server 300 then provides the outcome sequence to the player device 400. The lottery server 300 may provide an outcome sequence that may be played by the player (or automatically by the player device 400) over the course of several game sessions. For example, the lottery server 300 may transmit and store a predetermined number of outcomes at the player device 400. The player may then reveal the set of outcomes manually at the player device 400, or, alternatively, specify that the player device 400 display the outcomes in accordance with automated play parameters (e.g., once an hour, alternating between “scratch-off” and blackjack game formats).

In one example of providing outcome data, the lottery server 300 establishes communication with the player device 400 that is associated with the particular player. Specifically, the lottery server 300 accesses the player device database 700 and searches for the player device identifier 710 that matches the one stored in the players record in the automated session database 600 in field 695. The lottery server 300 then uses the player device address 720 (if necessary), which may be a pager or cellular telephone number, or the Internet protocol (IP) address of a set-top device, to establish communication with the player device 400.

Note that in various embodiments, more than one player device 400 may be associated with the particular player. Thus, results may be transmitted to a player's cellular telephone, PDA, pager, and/or other devices, for example, on a player's “buddy list”.

As described above, in one embodiment of the invention the player device 400 comprises a pager with a liquid crystal or other type of display. Thus communication of the outcome data to the player, which may even include a display of the revealed values of an instant lottery ticket on the display, permits a player to enjoy the excitement of the play without a physical presence at a lottery retailer location or lottery terminal establishment.

In one aspect of the invention, the remaining credit balance is communicated to the player along with the outcome data. Thus, when a player notes that his play may be terminated because his credit balance is running out, he has the opportunity to supplement the credit balance. The player can increase the credit balance by phoning the lottery authority and authorizing the lottery authority to increase the credit balance. The lottery authority personnel will appropriately enter the additional funds into the correct server database fields. Alternatively, the player may increase the credit balance by sending a command to the lottery server 300 (or other device) via, for example, a two-way pager or touch-tone wireless telephone.

In step 860, the lottery server 300 (and/or player device 400) determines whether a limiting criterion has occurred. Specifically, in one embodiment, the lottery server 300 accesses the record in the automated session database 600, as identified by the player ID 610, to determine whether any one of the limiting criteria have occurred.

The determination of whether any of the limiting criteria has occurred may be made by various comparisons, for example, by comparing any of: 1) the end time 630 to an internal clock of the lottery server 300; 2) the maximum number of games 640 to the actual number of games stored in RAM 330; 3) the current credit balance 570 to the limiting credit balance 650; and 4) the limiting maximum payout 660 to the actual payout. If none of the limiting criteria have occurred, operation of the system 200 proceeds from step 840, once again.

If any one of the limiting criteria has occurred, then, in step 865, the lottery server 300 stops the automated play session. Optionally, the lottery server may transmit a signal to the player device 400, thereby notifying the player that the automated session has ended.

If the player device 400 was locked-up during the automated session, it may remain locked-up until the player unlocks it (e.g., by providing a player ID or other verifiable information). In an alternative embodiment, the lottery server 300 also transmits an unlocking signal to the player device 400 upon the occurrence of a limiting criterion of play. The unlocking signal indicates to the player device 400 that it may allow manual play.

In yet another embodiment, information other than outcome data, such as messages, may be communicated to the player device 400. Such messages, as used herein, may include information generated by the lottery server 300 relating to, for example, the status of that particular lottery server 300. For example, such a message may indicate that the lottery server 300 has stopped functioning properly.

In yet another embodiment of the present invention, limiting criteria of play, actual limiting values, or both, are communicated to the player. For example, the player may be notified of the current credit balance 570 and the limiting credit balance 650, as well as the current number of games, as stored in RAM 330, and the maximum number of games 640 allowed.

In an alternative embodiment the outcome data transferred in step 855 of FIG. 8B need only include the payout, if any.

It will be appreciated by those skilled in the art that, while the player may select player parameter selections in the manner described above, the lottery authority may also set guidelines on automated play of lottery games. Thus, the lottery authority may limit the selectable range of player parameter selections, for example the frequency of games, to insure reasonably constant and speedy play. Further, the lottery authority may alter the range of player parameter selections to encourage play during times when the lottery server 300 or the player device 400 may be otherwise underutilized. For example, the lottery authority may permit a player device 400 to be played during late night hours, in an automated mode, at a slower speed and with a higher payout schedule. This would permit a player to start automated play during the nighttime hours when the device 400 may be otherwise unused. The lottery authority would benefit from increased play and revenue, while the player would benefit from potentially better payouts.

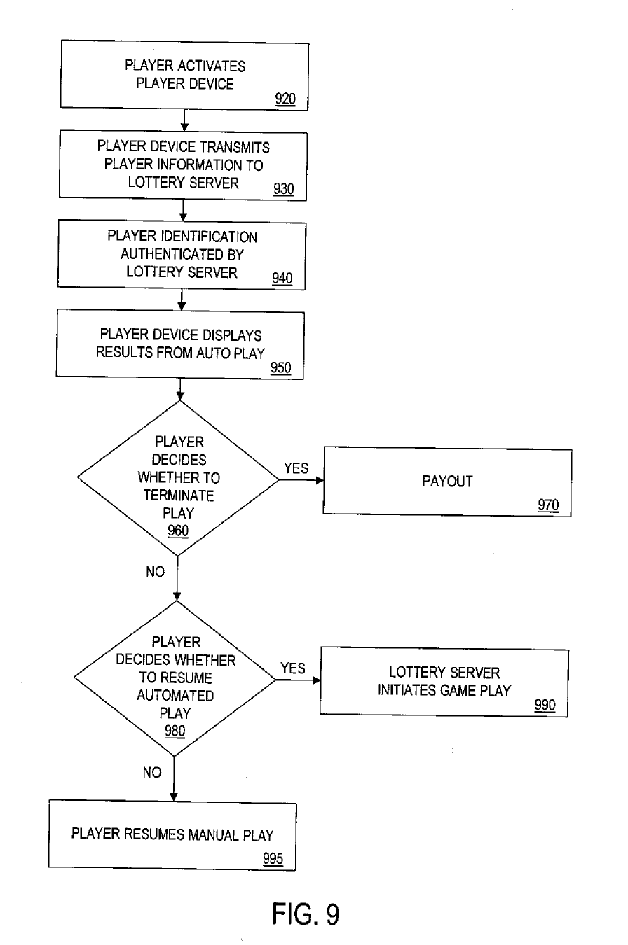

At any time during the operation of the system 200, as described with reference to FIGS. 8A and 8B, the player may manually terminate automated play via the player device 400. Such manual termination of automated play will now be described with reference to FIG. 9.

The player, in step 920, instructs the player device 400 to communicate with the lottery server 300 or otherwise activates the player device 400 by, for example, using a button on the keypad 430. The player device 400 determines information identifying the player as discussed above and, in step 930, the player device 400 transmits this information to the lottery server 300.

In step 940, the lottery server 300 optionally authenticates the player identifying information. Specifically, the lottery server 300 searches the automated session database 600 to determine whether the received player ID number and player device ID number are also present in a single record in the automated session database 600. If the information is present in a single record in the automated session database 600, the player identifying information may be deemed authentic.

In an alternative embodiment, the player may terminate his automated play session via any well-known communication means, for example, via an Internet website, regardless of whether that particular communication means was used to initiate the automated play. Accordingly, the player identifying information may be deemed authentic if the player ID number is in at least one record in the automated session database 600.

After authenticating the player identifying information (if desirable), the lottery server 300 transmits the results from the automated play to the player device 400 for display to the player in step 950. The results, which are displayed on display 420 preferably include the player's credit balance 570. The displaying of the results may also include, for example, all of the resulting numbers and/or values or only “highlights” of the winning numbers and values. Having read the results from the automated play session, as shown in step 960, the player may then decide to terminate play. In step 970, if the player decides to terminate play, then the player may receive a payout owed.

It will be understood that, should the player so desire, a complete audit of the automated play session is available. Such an audit would typically be provided by the lottery authority and/or upon request by the player, and could include a complete reporting of results for every play during the automated session.

On the other hand, if the player decides not to terminate play, then the player must decide whether to resume automated play, as shown in step 980. If the player decides to resume automated play, such play will continue as described with reference to FIG. 5B, steps 840-860, until a limiting criterion occurs or the player returns to manually terminate play. The resumption of automated play is shown as step 990.

As an alternative to resuming automated play, the player may decide instead to resume manual play of the player device 400 (e.g., the player will manually reveal instant lottery outcomes rather than have them automatically revealed). Step 995 illustrates the resumption of manual play.

As shown in step 970, the player may receive any payout due. The lottery authority may proceed to pay the player any amount less than or equal to the current credit balance 570 stored in the player's record. The personnel then adjust the credit balance 570 to reflect the disbursement.

In another alternative embodiment, the player may receive an offer to receive a prize or reward in lieu of any monetary, credit, or cash payout due. Such an offer may be communicated to the player, for example, by the lottery server 300 via the player device 400. Of course, such an offer may be communicated via the player device 400 during automated play.

In one embodiment of the present invention, the player device 400 may store and update the automated play information, including player identifying information, credit balance, player parameter selections, and actual limiting values, based on lottery information received from lottery server 300.

In another embodiment, upon completion of automated play, the player device 400 may prompt the player as to whether the player wishes to purchase another automated session. For example, the player device may query the player as to whether the player wishes to parlay all or a portion of winnings from a previous automated session into a future automated session.

Furthermore, the present invention encompasses automated play of lottery games that require a player to make decisions during play, such as which game play areas to reveal during an instant lottery ticket game. The inclusion of decision rules in the player parameter selections may account for the need to make decisions. Alternatively, decision rules may be applied to all players or may be otherwise outside of the control of the player. For example, all players playing an automated play session, or a certain subset of such players, may be forced to play according to a predetermined set of decision rules. Decision rules dictate the course of play based upon the current status of play. In short, because decision rules obviate the need for player decisions, automated play may proceed. Decision rules may include a particular strategy (e.g., a set of one or more locations to clear or “scratch” in a lottery game).

In an alternative embodiment, outcomes requiring a decision by the player may be stored and displayed to the player at a later time via the player device 400 at the player's request. After the outcome requiring a decision is stored, automated play may then continue with the next game. In accordance with this alternative embodiment, then, automated play could continue without the player's selection. The player could then play all the stored outcomes requiring the player's selection at a later time.

In an alternative embodiment, the player device 400 may provide “instant replays” of outcomes of games played during automated play, at the player's request. Replays may comprise all or a portion of the outcomes of the games played.

In an alternative embodiment, a first player could associate his automated play with a second player. In this way, outcomes and/or payouts provided to the second player could be made proportional to outcomes and/or payouts provided to the first player.

In accordance with one alternative embodiment, a limiting criterion may comprise the occurrence of one or more external event(s). An event may be indicated, for example, in the event field 690 of the automated session database 600. For example, an automated session may comprise transmitting one lottery outcome from the lottery server 300 to the player device 400 on a predefined schedule relative to one or more external events (e.g., relative to the lunar cycle). Similarly, an external event may comprise a generally unpredictable, random, or seemingly random event. For example, an automated session may comprise transmitting one lottery outcome from the lottery server 300 to the player device 400 each day the Dow Jones Industrial Average opens and/or closes over 10,500, or gains 0.5% or more.

According to some embodiments, lottery information (including outcome and/or payout information) may be transmitted or otherwise provided to a player device in the form of a digital audio file (e.g., an mp3 file), a digital image (e.g., a JPEG file), or a digital video file (e.g., an MPEG file). For example, lottery information may be included in an audio file, such as a voice announcing a payout or outcome (e.g., “Sorry, this audio lottery ticket is not a winner. Please play again!”), that the player device can play to indicate the lottery information for the player. In another example, lottery information may be included in one or more digital image files or in a video file. For instance, a first image file may indicate “unscratched” play areas of an electronic lottery ticket, and a second image file associated with the first may show the result of scratching off the player areas. The two image files may be displayed in succession, for example, to represent play of the lottery ticket.

According to some embodiments, digital files may be useful for providing game play using various types of player devices, such as portable mp3 players and other types of digital media players. In one embodiment, similar to the way in which paper instant scratch tickets are distributed, an on-line retailer may purchase outcomes from a lottery authority for reselling to customers. In another example, the lottery authority may operate as an on-line retailer. A player may be able to purchase one or more lottery games at an on-line retailer, for example, using a Web site or via a software application operable to download and manage digital content (e.g., Windows Media Player™ by Microsoft Corp., iTunes™ by Apple Corp.). The lottery information may then be provided to the player or player device (e.g., upon the player's request or automatically in accordance with one or more automated player parameters) by transmitting one or more digital media files (e.g., to the player's personal computer, PDA, or mobile telephone). In some embodiments, such files may also be downloaded from a personal computer or other computing device to one or more types of media players, such as an Apple® iPod™ or iPod photo™. Thus, some embodiments of the present invention provide for transmitting lottery information from player device to another, or from a computing device to a player device.

As discussed above, according to one or more embodiments of the present invention, lottery information may be communicated to a player and/or player device via postal mail. For example, a lottery authority, lottery agent, or retailer may generate or otherwise determine lottery outcomes and store the lottery information on a CD-ROM, DVD, USB flash drive, or other type of storage medium. The medium may then be mailed to the player, who may then view, listen to, or otherwise receive the lottery information (e.g., via a player device appropriate for the medium). According to one embodiment, lottery information may be provided in accordance with any of various play parameters, as discussed herein. For example, a player may indicate one or more types of games, specify a number of mailings the player would like to receive, specify a frequency of mailings, and/or specify a number of games the player would like to receive in each mailing. In some embodiments, a player may return (or may be required to return) any received media to the lottery authority or retailer (e.g., in order to receive any winnings), via postal mail or by returning the media to a lottery agent location. In one embodiment, another medium (e.g., including another set of tickets or other outcomes) may be mailed out once the previous medium (e.g., a DVD) is returned to the distributor (e.g., a lottery authority, a retailer, a lottery agent).

As noted above, in accordance with one embodiment, the player device 400 may comprise a set-top device, such as, for example, an addressable or interactive cable television set-top device. As discussed above, such a device may be in communication with one or more other device over a network (e.g., a network capable of transmitting audio content, video content, digital files, television signals, and/or media). In one example, the player device 400 may comprise the Explorer® 3250HD™ High-Definition Interactive Set-Top, manufactured by Scientific Atlanta. In another example, the player device may comprise a device in communication with a satellite dish for receiving media signals (e.g., from a cable television and/or Internet service provider).

In accordance with one embodiment, a player may initiate an automated session by registering a request for an automated session via a set-top device. For example, the player may access a dedicated channel of the cable television spectrum, where the player may provide (or pledge to provide) payment for the automated session (e.g., via an interactive menu). In one example, the player may agree to allow an amount of an initial wager to be charged against (and/or winnings be credited toward) an account balance. For instance, if the player is a customer of a cable television service provider, the wager may be charged against the customers cable service account. In one embodiment, the player may be billed for wagering by the service provider (e.g., as indicated in a monthly cable service billing statement).

If the request for the automated session is accepted, outcomes and/or other lottery information may be provided to the player, as discussed variously herein. In one example, outcomes may be transmitted to the set-top device from the lottery server 300 (e.g., via a cable television network) and communicated to the player via the player's television (e.g., using video and/or audio).

The use of set-top devices as player devices may be beneficial, in accordance with some embodiments, by enabling a lottery server 300 or lottery authority to determine a physical location (e.g., based on a billing or service address) associated with the requesting player device. For example, in one arrangement, an addressable set-top device may be associated with a particular network address (e.g., an IP address), which may be associated with a particular physical location or address (e.g., a customer's residence). Thus, a lottery authority may be able to accept or reject requests for lottery games based on information about the location of the set-top device. Such a capability may be beneficial, for example, if it is desirable to prevent play and/or purchase of lottery games from a particular jurisdiction (e.g., in a jurisdiction that prohibits such activity).

In some embodiments, access to games and/or wagering may be restricted and/or customizable (e.g., by a customer, by a service provider, or by a lottery authority) based on parental or user control systems, password systems, and/or PIN arrangements. Various types of access and security controls available for set-top boxes and addressable devices that may be useful in controlling access will be understood by those of skill in the art.

Some embodiments discussed herein provide for an account of a player to be adjusted according to wagers and/or winnings of a player. Alternatively, or in addition, a claim check, voucher, receipt, or other proof of any winnings due a player can be mailed to the player (e.g., along with his bill). In another example, an e-mail may be sent to the player with information (e.g., in the text of the email, in an attached file, or at a website available via an included hyperlink) that the player may print (e.g., using a printer in communication with a personal computer). The player can then redeem the claim check through an appropriate redemption channel (e.g., at a physical retailer, or from a lottery authority). In one embodiment, a voucher may be provided to a player if the player has achieved a predetermined minimum win and/or a predetermined minimum account balance. For example, winnings less than $10 could be charged to toward a player's cable bill, but for winnings greater than $10 a check in the appropriate amount would be mailed to the player.

The following paragraphs include descriptions of some embodiments of the present invention. The embodiments are labeled only for convenience and purposes of incorporation of a particular description by reference (e.g., in the description of another embodiment). Such labels do not imply relative importance or ranking of the embodiments.

Embodiment A. A method comprising: receiving data indicating a request by a player for an automated session, in which the automated session comprises a plurality of lottery outcomes; determining at least one parameter associated with the automated session; determining at least one lottery outcome; and providing the at least one lottery outcome based on the at least one parameter.

Embodiment A-CM. A computer-readable medium storing instructions configured to direct a processor to perform the method of embodiment A.

Embodiment A-AP. An apparatus comprising a processor and the computer-readable medium of embodiment A-CM in communication with the processor.

Embodiment A.1. The method of embodiment A, further comprising: determining a limiting criterion based on the at least one parameter; determining if the limiting criterion has occurred; and terminating the automated session if the limiting criterion has occurred.

Embodiment A.2. The method of embodiment A, further comprising: determining a payout based on the at least one lottery outcome.

Embodiment A.3. The method of embodiment A.2, further comprising: determining an account associated with the player, and crediting the account based on the payout.

Embodiment A.4. The method of embodiment A, in which the at least one parameter comprises at least one of a bet amount, a type of game, a period of time between games, a time to provide an outcome, a predetermined event, a start time, an end time, a number of outcomes, a number of outcomes without a win, a number of outcomes without a loss, a balance of an account, a number of losses, a number of wins, an amount of a payout, a total amount won, a total amount bet, a rate of losing, and a rate of winning.

Embodiment A.5. The method of embodiment A, further comprising: receiving a request by the player for a sequence of lottery outcomes; in which providing comprises: providing the sequence of lottery outcomes; and in which determining the at least one lottery outcome comprises: determining the sequence of lottery outcomes.

Embodiment A.6. The method of embodiment A.5, further comprising: determining a device associated with the player; and in which providing the sequence of lottery outcomes comprises: storing the sequence of lottery outcomes at the device.

Embodiment A.7. The method of embodiment A, further comprising: determining a device associated with the player; and in which providing comprises: transmitting an indication of the at least one lottery outcome to the device.

Embodiment A.8. The method of embodiment A, in which determining the at least one lottery outcome comprises: determining the at least one lottery outcome based on the at least one parameter.

Embodiment A.9. The method of embodiment A, in which determining the at least one lottery outcome comprises: receiving the at least one lottery outcome from a lottery server.

Embodiment B. A method comprising: initiating an automated session, in which the automated session comprises a plurality of instant lottery games; determining at least one parameter associated with the automated session; determining at least one instant lottery game; and providing the at least one instant lottery game based on the at least one parameter.

Embodiment B-CM. A computer-readable medium storing instructions configured to direct a processor to perform the method of embodiment B.

Embodiment B-AP. An apparatus comprising a processor and the computer-readable medium of embodiment B-CM in communication with the processor.

Embodiment B.1. The method of embodiment B, further comprising: determining an outcome of the at least one instant lottery game.

Embodiment B.1. The method of embodiment B.1, further comprising: providing the outcome.

Embodiment B.2. The method of embodiment B.1, further comprising: determining a payout based on the outcome.

Embodiment B.3. The method of embodiment B.2, further comprising: determining an account associated with the automated session, and crediting the account based on the payout.

Embodiment B.4. The method of embodiment B, further comprising: determining a limiting criterion based on the at least one parameter; determining if the limiting criterion has occurred; and terminating the automated session if the limiting criterion has occurred.

Embodiment B.5. The method of embodiment B, in which determining the at least one instant lottery game comprises: determining the at least one instant lottery game based on the at least one parameter.

Embodiment B.6. The method of embodiment B, in which the at least one parameter comprises at least one of: a bet amount a type of game, a period of time between games, a time to provide a game, a predetermined event, a start time, an end time, a number of games, a number of games without a win, a number of games without a loss, a balance of an account, a number of losses, a number of wins, an amount of a payout, a total amount won, a total amount bet, a rate of losing, and a rate of winning.

Embodiment B.7. The method of embodiment B, further comprising: determining a device associated with the automated session; and in which providing comprises: transmitting an indication of the at least one lottery game to the device.

Embodiment B.8. The method of embodiment B, further comprising: storing an indication of the at least one instant lottery game.

Embodiment B.9. The method of embodiment B.8, in which storing comprises: determining a device associated with the automated session; and storing the indication of the at least one instant lottery game at the device.

Embodiment B.10. The method of embodiment B, in which determining the at least one instant lottery game comprises: determining the at least one instant lottery game based on the at least one parameter.

Embodiment B.11. The method of embodiment B, in which determining the at least one instant lottery game comprises: receiving the at least one instant lottery game from a lottery server.

Embodiment B.12. The method of embodiment B, in which providing the at least one instant lottery game comprises: determining a device that is associated with the automated session; and transmitting the at least one instant lottery game to the device.

Embodiment B.13. The method of embodiment B.12, in which the device is associated with an Internet protocol address.

Embodiment B.14. The method of embodiment B, in which providing the at least one instant lottery game comprises: transmitting the at least one instant lottery game via wireless communication.

Embodiment C. A method comprising: determining at least one parameter associated with an automated session, in which the automated session corresponds to a set of instant lottery outcomes; and providing the set of instant lottery outcomes based on the at least one parameter.

Embodiment C-CM. A computer-readable medium storing instructions configured to direct a processor to perform the method of embodiment C.

Embodiment C-AP. An apparatus comprising a processor and the computer-readable medium of embodiment C-CM in communication with the processor.

Embodiment C.1. The method of embodiment C, in which the at least one parameter comprises at least one of: a bet amount, a type of instant lottery game, a period of time between outcomes, a time to provide an outcome, a predetermined event, a start time, an end time, a number of outcomes, a number of outcomes without a win, a number of outcomes without a loss, a balance of an account, a number of losses, a number of wins, an amount of a payout, a total amount won, a total amount bet, a rate of losing, and a rate of winning.

Embodiment C.2. The method of embodiment C, further comprising: determining session data based on the set, determining a player associated with the automated session; and providing at least a portion of the session data to the player.

Embodiment C.3. The method of embodiment C, further comprising: determining session data based on the set; determining a device associated with the automated session; and transmitting at least a portion of the session data to the device.

Embodiment C.4. The method of embodiment C, further comprising: determining a limiting criterion based on the at least one parameter; determining if the limiting criterion has occurred; and terminating the automated session if the limiting criterion has occurred.

Embodiment D. A method comprising: determining at least one preference of a player for delivery of game outcomes; determining a plurality of game outcomes; and in accordance with the at least one preference for delivery of game outcomes, transmitting the plurality of game outcomes to a device that is associated with the player.

Embodiment D-CM. A computer-readable medium storing instructions configured to direct a processor to perform the method of embodiment D.

Embodiment D-AP. An apparatus comprising a processor and the computer-readable medium of embodiment D-CM in communication with the processor.

Embodiment D.1. The method of embodiment D, further comprising: storing an indication of the at least one preference for delivery in a database.

Embodiment D.2. The method of embodiment D, further comprising: retrieving the at least one preference for delivery from a database.

Embodiment D.3. The method of embodiment D,in which determining the at least one preference of the player for delivery of game outcomes comprises: receiving from the player an indication of the at least one preference for delivery of game outcomes.

Embodiment D.4. The method of embodiment D, further comprising: receiving from the player a preference for revealing game outcomes; and revealing at least one of the plurality of game outcomes via the device in accordance with the preference for revealing game outcomes.

Embodiment D.5. The method of embodiment D, further comprising: revealing at least one of the plurality of game outcomes via the device in response to a signal from a lottery server.

Embodiment D.6. The method of embodiment D, in which transmitting the plurality of game outcomes to the player device that is associated with the player in accordance with the at least one preference for delivery of game outcomes comprises: transmitting a first game outcome to the device; and transmitting a second game outcome to the device a predetermined period of time after transmitting the first game outcome.

Embodiment D.7. The method of embodiment D.6, in which no request for delivery of the second game outcome is received from the player after the first game outcome is transmitted.

Embodiment D.8. The method of embodiment D, in which transmitting the plurality of game outcomes to the device that is associated with the player in accordance with the at least one preference for delivery of game outcomes comprises: automatically transmitting at least one of the plurality of game outcomes to the device in accordance with a schedule.

Embodiment E. A method comprising: receiving a request by a player to purchase a plurality of lottery game outcomes; receiving at least one selection by the player for how lottery game outcomes are delivered to the player, in which each selection comprises at least one of the following: an indication of a time of day to provide a lottery game outcome to the player, an indication of a number of a cellular telephone, an indication of a period of time between delivery of lottery game outcomes, and an indication of an e-mail address; determining a first lottery game outcome; communicating the first lottery game outcome to the player in accordance with the at least one selection for how lottery game outcomes are delivered to the player; and updating a credit balance associated with the player based on the first lottery game outcome.

Embodiment E-CM. A computer-readable medium storing instructions configured to direct a processor to perform the method of embodiment E.

Embodiment E-AP. An apparatus comprising a processor and the computer-readable medium of embodiment E-CM in communication with the processor.

Embodiment F. A method comprising: receiving a request to provide a plurality of lottery game outcomes to a device of a player; receiving from the device at least one parameter for providing lottery game outcomes to the player, the at least one parameter including a preference for delivery of the lottery game outcomes to the device; determining a first lottery game outcome; and transmitting the first lottery game outcome to the device accordance with the preference for delivery of the lottery game outcomes.

Embodiment F-CM. A computer-readable medium storing instructions configured to direct a processor to perform the method of embodiment F.

Embodiment F-AP. An apparatus comprising a processor and the computer-readable medium of embodiment F-CM in communication with the processor.

Embodiment F.1. The method of embodiment F, in which the preference for delivery comprises at least one time of day at which to provide a lottery game outcome.

Embodiment F.2. The method of embodiment F, in which the preference for delivery comprises a period of time between providing lottery game outcomes.

Embodiment F.3. The method of embodiment F.2, further comprising: automatically transmitting a second lottery game outcome to the device after the period of time has passed since transmitting the first lottery game outcome.

Embodiment F.4. The method of embodiment F, in which the preference for delivery comprises a format for outputting the lottery game outcomes at the device.

Embodiment F.5. The method of embodiment F, in which the preference for delivery comprises a network address.

Embodiment F.6. The method of embodiment F.5, in which the network address comprises at least one of: an e-mail address, and a telephone number.

Embodiment F.7. The method of embodiment F, in which the lottery game outcomes comprise predetermined outcomes.

Embodiment F.8. The method of embodiment F, in which the lottery game outcomes comprise random outcomes.

There has thus been provided a method and apparatus of operating a lottery game, for example, an instant lottery ticket game. The invention further permits a player to enjoy all of the benefits of lottery games, such as the enjoyment of viewing lottery game outcomes, without necessitating a physical presence at a lottery agent or physical play of a “scratch-off”-type lottery game.

Although the present invention has been described in terms of certain preferred embodiments, other embodiments that are apparent to those of ordinary skill in the art are also intended to be within the scope of the present invention. Accordingly, the scope of the present invention is intended to be limited only by the claims appended hereto.

1. A method comprising:
receiving an indication of a request by a player to purchase a plurality of instant lottery games;
receiving at least one selection by the player for how instant lottery games are to be delivered to the player; and
communicating at least one instant lottery game to the player in accordance with the at least one selection.

2-49. (canceled)
